(19) United States
(12) Patent Application Publication
(10) Pub. No.: US 2001/0032192 A1
(43) Pub. Date: Oct. 18, 2001

(54) Method and apparatus for improved financial instrument processing

(76) Inventors: Laxmiprassad Putta, Cambridge, MA (US); Sudhakar Durairaj, Watertown, MA (US); Sridhar Ramachandran, Watertown, MA (US); James Lowell Frankel, Lexington, MA (US)

Correspondence Address: Ronald J. Kransdorf, Wolf, Greenfield & Sacks, P.C., 600 Atlantic Avenue, Boston, MA, 02210, US

(21) Appl. No.: 09/735,064

(22) Filed: Dec. 11, 2000

Related U.S. Application Data
(60) Provisional application No. 60/170,031, filed on Dec. 10, 1999.

(51) Int. Cl. G06F 17/60; H04K 1/00; H04L 9/00

(52) U.S. Cl. 705/76; 705/39; 705/65; 705/67; 705/78

(57) ABSTRACT

A method and apparatus are provided for issuing secondary programmable account numbers (SPANs) to a customer or customer-designated party, each of which SPANs is associated with a customer primary account or other financial instrument, and each of which SPANs has selected usage parameters assigned thereto. SPANs may be issued as a book, with usage parameters assigned to the book in addition to or instead of individual SPANs. When a SPAN is presented to a merchant for payment, the SPAN, including compliance with usage parameters, is verified and appropriate action taken based on either verification or failure of verification.

### RELATED APPLICATION

This application claims priority from Provisional Application Ser. No. 60/170,031, filed Dec. 10, 1999

### FIELD OF THE INVENTION

This invention relates to transaction processing of financial instruments such as credit cards, and more specifically to methods and apparatus for improving the security, flexibility and privacy of such transactions.

### BACKGROUND OF THE INVENTION

Since the inception of credit cards, limits have been set on their usage. Credit card issuing institutions place limits on credit cards typically to reduce overuse thereof.

For example, credit cards generally have a credit limit set on them. Purchases made over the credit limit will not be accepted by the credit card issuing institution. Similarly an expiry date can be set on a credit card to limit its validity. With the widespread deployment of networks to perform credit card processing, the use of terminal point-of-sale devices to perform credit card authorizations has become common. Today, credit card payments are first authorized and later charged after the goods are shipped.

Credit card issuing institutions offer flexibility to customers in establishing their credit card parameters, such as the account to be charged and monthly spending limits. For example, corporate credit cards offer the flexibility of charging payments made on a secondary credit card to its primary (master) credit card account. Multiple secondary credit cards can be issued on a primary credit card. Moreover, the owner of the primary credit card can impose constraints on the usage of the secondary credit cards, such as setting the monthly credit limit. The use of such cards is widespread in businesses and families.

Customers can make credit card payments even if the credit card is not physically presented to the merchant. Orders can be placed by telephone or mail, and payments can be made using the credit card number, along with authentication information such as expiration date, cardholder name as it appears on the card, billing address and in some cases CVV2 number. With the recent boom in online retailing, more customers use credit cards in such “card-not-present” transactions.

However, credit card payments over the Internet are susceptible to risk of fraud. For transactions where the customer physically presents the card at the point-of-sale, the merchant can authenticate that the card belongs to the customer presenting the card (for example, by comparing a signature to the signature on the card, by comparing the person presenting the credit card to a photograph on the card, or by asking for additional identification). But, for “card-not-present” transactions, the only way of authenticating is by checking that the authentication information provided by the customer is correct. Though this authentication mechanism is often acceptable, it's by no means adequate. If a malicious agent manages to acquire the card number and the authentication information, then he can commit fraud very easily. The card number and authentication information can very easily be obtained by breaking into the merchant databases. There are known instances of such break-ins. The cardholder will not be able to detect this fraud until he receives his monthly statement. Then the cardholder has to go through the hassle of disputing the transaction.

In another malicious scenario, the merchant can overcharge the card. In a “cardnot-present” transaction, the customer has no control over the amount the merchant is charging. A fraudulent merchant can very easily overcharge the card or even charge the account twice (double charge).

In another scenario, if the customer gives his card for recurring payments such as to pay an ISP, to pay for phone service, or to pay for newspaper or magazine subscriptions, the service provider can charge the card on a periodic basis. If the customer cancels the service there is a risk that the service provider's billing systems are not updated on time and the customer's card is charged. In this instance the cardholder has to recognize that it's an unauthorized charge and dispute the transaction with either the service provider or the issuing bank.

Many customers are uncomfortable making purchases online because of the above and other reasons. Online shops may not succeed because of the reluctance of new customers to buy online.

Credit card institutions have been promoting the use of credit cards by protecting the customers from fraud. In the USA, for example, the liability in case of fraud is limited to $50 if the customer reports the case of fraud properly. Although such protection improves credit card usage, the institutions need to bear the fraudulent charges made or pass them on to the merchant. Customers, on the other hand, need to be aware of the risk of fraudulent charging and must look at their monthly statements with care.

There have been many attempts to overcome the problem of credit card fraud for “card-not-present” transactions.

One of the notable developments is the Secure Electronic Transaction (SET) protocol created by well-known technology and credit card institutions. This protocol was developed to address the security issues of “card-not-present” transactions conducted over the Internet. It involves the card issuing bank, the customer and the merchant and provides a detailed protocol for encryption of data and identification and certification of various parties. It's well published by the credit card institutions, but due to the investment required by the merchants, adoption has been limited.

Another method being popularized by a number of credit card institutions are smart cards. Smart cards are credit cards with an embedded chip which can hold information about the cardholder. They implement different types of request-response and encryption schemes to ensure security. U.S. Pat. No. 5,317,636 (Vizcaino) explains how a typical smart card system works. Smart cards require a special reading device so that the information stored on the chip can be interpreted. This would mean changes to the existing point-of-sale (POS) terminals, which could be very costly, and can be of limited value for Internet or other card-not-present transactions.

Another method is to use a system such as DigiCash, U.S. Pat. No. 5,712,913 (David Chaum), where the information is split between various parties, so that no one database can be hacked to gain access to all the information required to commit fraud.

Various approaches have been developed to control the use of the card, thereby making the card more secure. Japanese Patent No. Hei 6-282556 describes a system in which a credit card number can be used only once and in which personal information and use limits are recorded on the card. A special card-reading device reads the information from the card and checks if the usage conditions permit the card to be used. The card information will be transferred to the issuing institution only if the use conditions are valid. This system would again require changes to the existing POS terminals.

Other approaches were developed to use proxy numbers instead of the actual credit card to do online transactions for example, U.S. Pat. No. 6,000,832, U.S. Pat. No. 5,833,816 (Franklin et al.). This system assumes creation of an electronic commerce card that is maintained for the customer at the bank. This online commerce card is assigned a real customer account number at the bank. When the customer wants to conduct an online transaction, the customer requests a transaction number from the bank. This transaction number is given to the merchant. When the merchant presents the number to the bank, the bank identifies that the number is a proxy for an online commerce card and charges the transaction to the real account number. This number is valid for only one transaction. This is a good system to control fraud, but a good number of Internet purchases are shipped separately. In this case, the present system will deny the second authorization because it relates to a separate transaction.

While security is a major concern in the use of credit cards, particularly on the Internet, there are also other concerns with the current systems. One major concern is privacy, credit card transactions by an individual being utilized by merchants and others to build up a profile on the individual which is used for marketing and other purposes. Privacy concerns are a factor limiting more extensive use of credit cards in connection with E-commerce and thus in limiting the expansion of E-commerce.

Further, while existing credit cards offer some flexibility, as indicated above, in use of credit cards, the flexibility and control afforded to a user in the use of credit card accounts while maintaining security and privacy, is still fairly limited. Greater flexibility is for example desirable in being able to control duration and credit/spending limits on a card, merchants with whom the card can or cannot be used, number of uses, use velocity and many other factors. Further, while credit card numbers are required for many types of transactions, including most E-commerce transactions, credit cards are not readily available in some parts of the world or to some individuals. A capability of being able to conduct credit card-like transactions, which may be transparent to the merchant, from a bank checking account, savings account, or other financial instrument is therefore also highly desirable.

Finally, there is a huge investment in existing POS terminals and in existing systems for processing credit card transactions. Therefore, any improvements required to address the above security, privacy, flexibility and other concerns should require minimum changes in existing terminals/systems both to minimize implementations, costs and to facilitate rapid implementations.

Therefore, a need exists for more secure, private and flexible methods of processing transactions and payments based on existing credit card processing infrastructure while requiring minimal changes thereto.

### SUMMARY OF THE INVENTION

In accordance with the above, this invention provides a system and method for facilitating access to financial instruments such as credit and debit card accounts, checking accounts, bank accounts and the like. Secondary programmable account numbers (SPANs) are issued in response to verified customer requests, verification of a customer request being provided for example by a verification module. Each SPAN is associated with at least one customer financial instrument, and each span has usage parameters assigned thereto. When a SPAN is presented to a party for payment, an authorization module receives request for authorization from such party. Such module may authenticate the SPAN verify that usage parameters for the SPAN have been complied with, deny authorization if the SPAN is not authenticated or if usage parameters for the SPAN are not complied with, and, if the SPAN is authenticated and usage parameters are complied with, update usage parameters based on the authorization request, update the associated customer primary account/financial instrument and send an authorization output.

More specification, the invention provides a module for issuing secondary programmable account numbers (SPANs) to a customer, which module includes a verification module which receives SPAN requests and verifies the validity of such requests; a generating module operative in response to a verified SPAN request for providing at least one SPAN, each SPAN being associated with at least one customer primary account/financial instrument; a usage module assigning usage parameters to the SPANs; and an issuing module which issues each SPAN to a customer specified party, the issued SPAN being usable only within the assigned usage parameters. The invention also includes a method for issuing SPANs to a customer which includes the customer inputting a SPAN request to an issuing system; the system verifying at least one of the customer and the request; the system providing at least one SPAN in response to a verified SPAN request, each SPAN being associated with a selected customer primary account/financial instrument; the system assigning usage parameters to the SPANs; and the system issuing each SPAN to a customer specified party, the issued SPAN being usable by such party only within the assigned usage parameters. Either the module or method may include a memory storing preferred usage parameters for the customer, which preferred usage parameters are used as default usage parameters for each SPAN for the customer. Each SPAN request may also include at least one usage parameter, the at least one usage parameter of the request being assigned to the corresponding SPAN in lieu of the corresponding preferred usage parameter. Where no preferred usage parameters are provided, the usage parameters included with the SPAN request are utilized as assigned usage parameters. Usage parameters can include, but not are not limited to, at least two of SPAN duration, SPAN face value, SPAN credit limit, permitted merchants, excluded merchants, value velocity, use velocity, period of use, and number of uses for the SPAN. A mechanism may be provided for altering at least one of the usage parameters after the SPAN has issued in response to a request from the customer and/or the party to whom the SPAN is issued.

At least selected SPANs may be issued to a third-party designated by the customer. The customer may also have a plurality of primary accounts or other financial instruments, a mechanism being provided for selecting the financial instrument with which each SPAN is associated. For some embodiments, the financial instrument selected for each generated SPAN is the same as the instrument selected for the previously generated SPAN unless the customer otherwise indicates, for example in the SPAN request. The financial instrument selected for a SPAN can also be changed by the customer after the SPAN has issued.

For some embodiments, a plurality of acceptable SPANs are generated and stored. When a SPAN request is received, at least one SPAN is then provided from the stored acceptable SPANs. A magstripe writing device may also be provided, the writing device recording a SPAN to be issued on a magstripe of a suitable token. A plurality of SPANs may also be provided and issued as for example a book to which the usage parameters are assigned. At least one usage parameter may be assigned to each book, each SPAN in the book being usable so long as the cumulative use of the SPANs for the book do not exceed any usage parameter assigned to the book. However, usage parameters may be assigned to each SPAN of the book in addition to the usage parameters assigned to the book.

A SPAN may be usable to access funds from a customer selected financial instrument, for example a customer checking account. A SPAN assigned to a check and may be usable as a check also as a credit card number. Where financial networks having given protocols utilize the module and method of this invention, a bridge may be included permitting use of SPANs across such financial networks.

One usage parameter may be SPAN duration, a SPAN normally remaining viable for its assigned duration. A customer may be provided with the ability after a SPAN is issued to change its assigned duration. Time durations for SPANs may be set in relatively small time intervals, for example time intervals not exceeding days. The system may also detect the issuance of an excessive number of SPANs to a customer during a given time interval and/or an unusual pattern of SPANs request for a customer, and the system may at least terminate the issuing of new SPANs for the customer in response to such detection.

The invention may also include an authorization module which receives request for authorization from a party to whom a SPAN, issued as indicated above, has been presented for payment, the module authenticating the SPAN, verifying that usage parameters for the SPAN have been complied with, denying authorization if it cannot authenticate the SPAN or if usage parameters for the SPAN are not complied with and, if the SPAN is authenticated and usage parameters met, updating usage parameters based on the authorization request, updating the associated customer financial instrument and sending an authentication output. Similarly, the invention includes a method for authenticating requests for authorization from a party to whom a SPAN, issued as described above, is presented for payment, which method includes: authenticating the SPAN, verifying that usage parameters for the SPAN have been complied with, denying authorization of the SPAN is not authenticated or if usage parameters for the SPAN are not complied with, and, if this SPAN is authenticated and usage parameters are complied with, (i) updating usage parameters based on the authorization request, (ii) updating the associated customer primary account, and (iii) sending an authorization output.

Either the authorization module or method may involve the person authorized to use a SPAN having a token which facilitates identification of the person from a remote site, the authorization module or system receiving information from the token and utilizing such information to verify that the party is authorized to use the SPAN for the received request. The token may be a dongle, a card with a magstripe or a device generating a time varying value which is substantially unique to an individual at each time interval. For some embodiments, once a SPAN is presented for payment to a given party, the authorization module permits such SPAN to be used thereafter only for payments to such party. A usage parameter may be the number of times a SPAN may be used, some embodiments treating all items ordered together on a SPAN as a single use, even if the items are shipped and/or invoiced separately. For some embodiments, the identity of the party to whom the SPAN is issued is not revealed to the party to whom the SPAN is presented for payment and is not required either as an input or an output from an authentication module. One option would be to provide a pseudo identity for the person using the SPAN to the merchant or other party to whom the SPAN is presented for payment. The authorization module and/or method preferable includes at least one fraud detection mechanism. For example, an unusual pattern of authorization requests from a party requesting such authorizations and/or an unusual pattern of use for SPANs previously received by such party may serve as an indication of potential fraud. At least notification to a customer over appropriate media may be provided of at least any suspicious authorization request for a SPAN issued at the request of such customer. Where there are fraud detection programs in effect for the primary account/financial instrument, use of such programs may be facilitated by mapping SPANs to the corresponding financial instrument for such programs. A plurality of purses may also be provided for at least selected SPANs, each purse being for a different category of payments, each received authorization request for a SPAN being allocated to the appropriate purse.

The foregoing and other objects features and advantages of the invention will be apparent from the following more particular description of a preferred embodiment of the invention as illustrated in the accompanying drawings, the same reference numeral being utilized for common elements in the various figures.

### IN THE DRAWINGS

FIG. 1 is a schematic representation of an illustrative embodiment integrated with financial networks.

FIG. 2 is a flow diagram of the authorization process that occurs when a SPAN is used in credit/debit transaction.

FIG. 3 is a flow diagram of the account registration process.

FIG. 4 is a flow diagram showing the relationship between a primary account and SPANs.

FIG. 5 is a diagram of modifiable and non-modifiable authorization parameters.

FIG. 6 is a flow diagram of the authorization process.

FIG. 7 is a diagram of the customer module and associated tools.

FIG. 8 is a flow diagram of authorization parameters modification process.

FIG. 9 is a flow diagram of a SPAN-issuing process.

FIG. 10 is a flow diagram of SPAN-generation process.

FIG. 11 is a diagram of the service module.

FIG. 12 is a diagram of the integration of different payment methods.

FIG. 13 is a flow diagram of the single purchase authorization.

### DETAILED DESCRIPTION

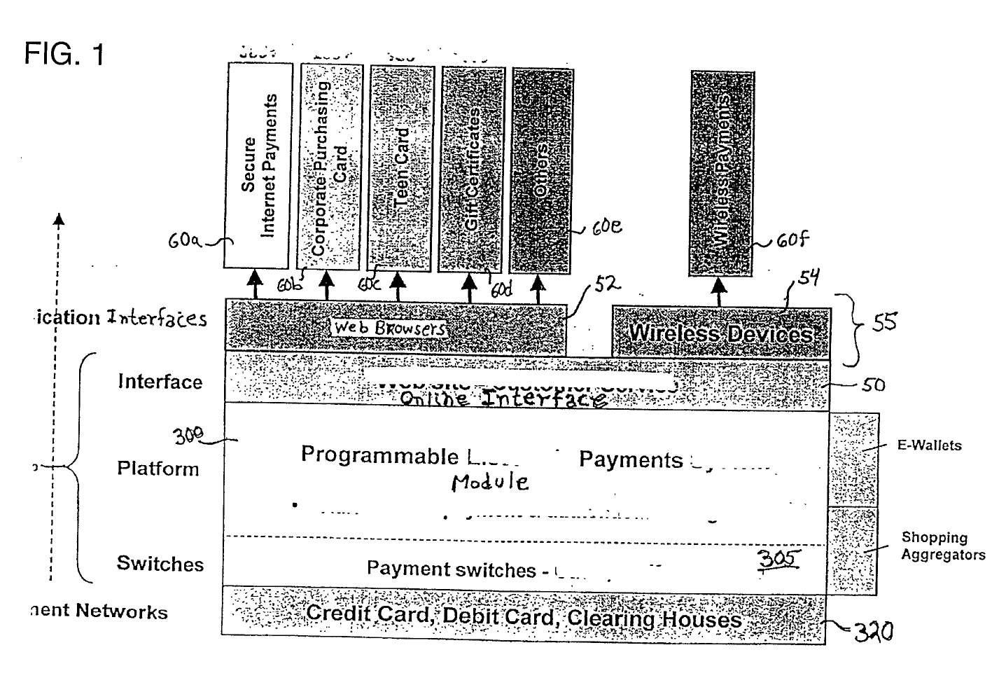

With reference to the figures, an illustrative embodiment of the current invention is now described. FIG. 1 is a schematic representation of the illustrative embodiment 30 of the invention integrated with financial networks 320 and communication interfaces 55. The illustrative embodiment 30 includes payment switches 305, programmable payments module 300 and an online interface 50. As used in this application, a module may be a software program or a hardware module or a combination of the two. Programmable payment module 300 may include a network of service providers, such as financial institutions, internet services providers, money management software providers and other organizations which provide support for the programmable payment module and its databases. In the illustrative embodiment, programmable payments module 300 is implemented as a stand-alone software program running on several computers, each containing at least one processor, a memory cache, at least a primary memory element and at least one memory disk. Online interface 50 is implemented as a software module that is integrated with a software web server (not shown) serving web pages to customers 100.

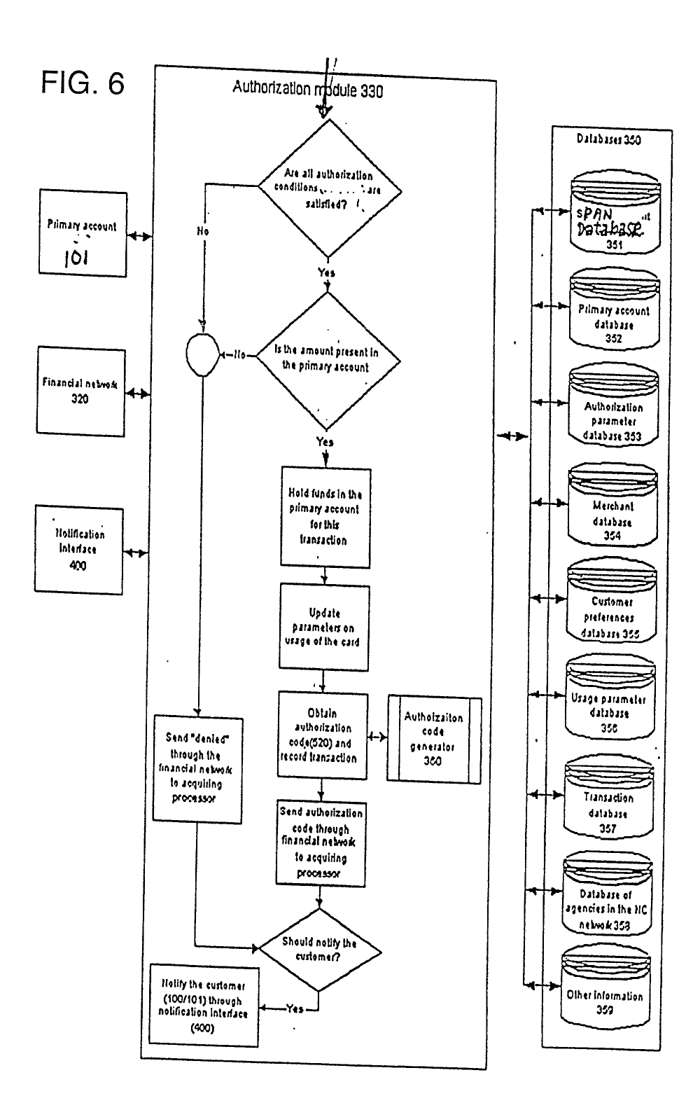

Payment switches 305 interface to standard or proprietary financial networks 320. Those networks may include credit/debit card networks, clearing houses and other private or public networks. Financial networks 320 are accessed when an authorization process for SPAN (see FIG. 6) requires authorization from an institution that issued a particular primary financial instrument.

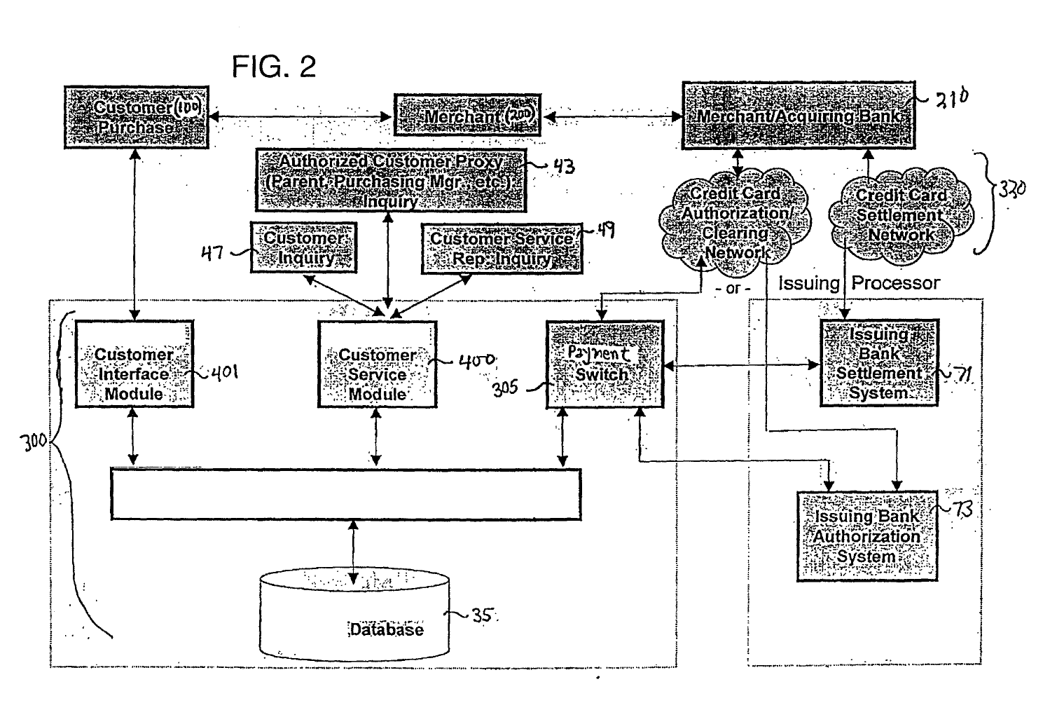

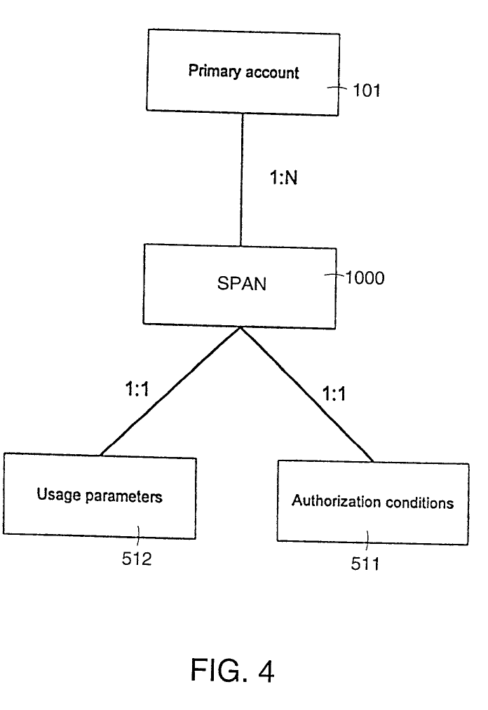

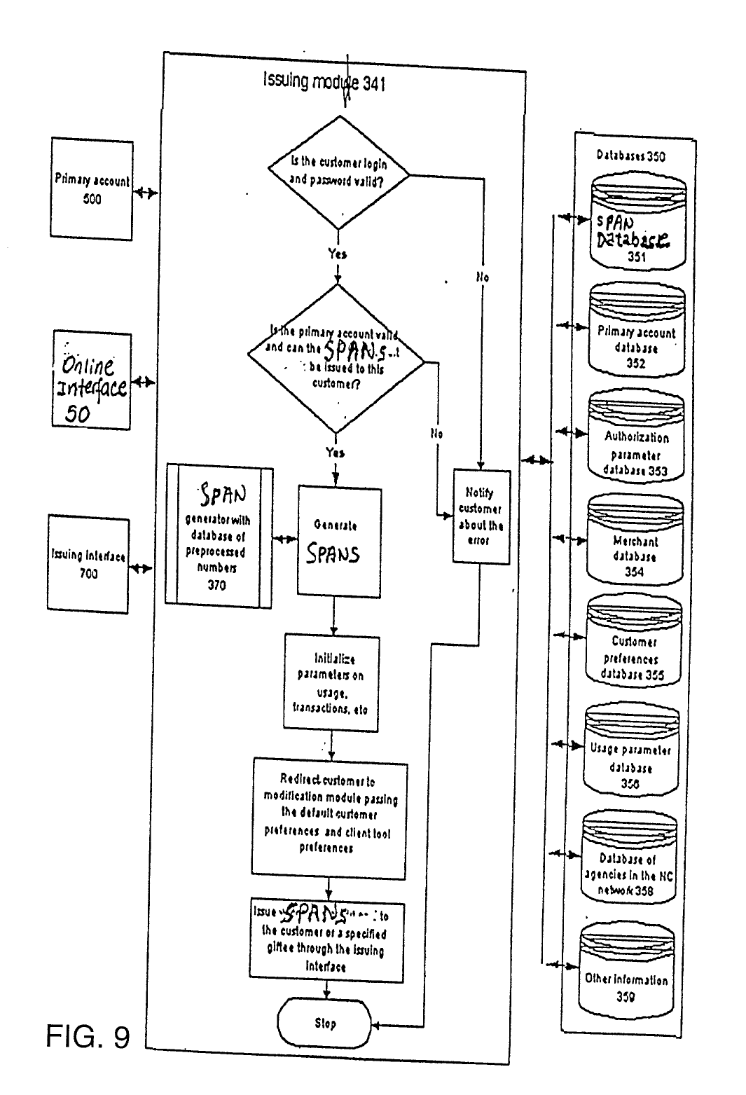

A customer 100 (see FIG. 2) has a single primary account located on a primary accounts database 352 (see FIG. 6) within the programmable payments module 300. Customers 100 must register at least one primary financial instrument with their accounts. A primary financial instrument may be a credit or debit card, a checking account, a savings account or other financial instruments that allow customers to draw funds on them. Programmable payments module 300 is operative to issue Secondary Payment Authentication Numbers (SPANs) to registered customers upon their request (see FIG. 9). Each SPAN is associated with a primary financial instrument of customer chosen from a set of primary financial instruments registered with primary account 101 (see FIG. 4). Customer 100 can associate more than one SPAN with any financial instrument. Charges made on SPANs are made to the corresponding financial instrument. Alternatively, a SPAN can have a stored monetary value physically stored on it or associated with it in for example programmable payments module 300 in order to be used as a debit instrument on that monetary value.

Online interface 50 can be for example a web site onto which a customer 100 can login in order to create a primary account, generate new SPANs, modify preference parameters or perform other tasks. Customers can access online interface 50 through communication interfaces 55. Communication interfaces 55 may include internet of web browsers 52 and various wireless devices 54.

In addition to online interface 50, programmable payments module can be accessed through associated E-Wallets 70 and shopping aggregators 72, such that customer information and preferences are retrieved from those in E-Wallets 70 or aggregators 72.

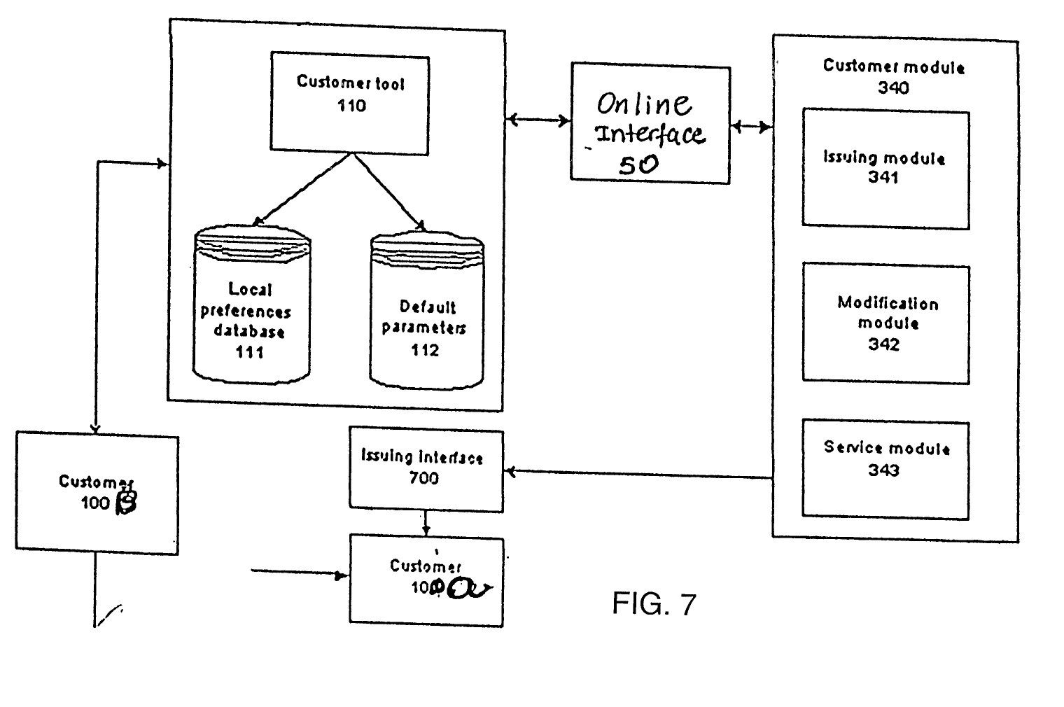

Customers 100 can use SPANs in a variety of situations. In FIG. 1, some of the possible commercial situations 60 are shown. One such situation is situation 60a, where customers 100 use SPANs in online commerce, as they would use normal credit or debit cards. SPANs can have a variety of user-modifiable preference conditions (see FIG. 7), which facilitate their use as a substitution for ordinary credit cards in online transactions.

In a situation 60b, SPANs are used in association with a corporate credit card, as secondary credit card numbers given out to employees. In this situation, an employee (not shown) may receive a SPAN which is only valid of example for one use, or for use with a limited credit limit or for use for limited purposes. The number of uses, credit limits and other conditions may be set on a per-SPAN basis (see FIG. 7), and, thus, on a per-employee basis, and may be modified as required after the SPAN is issued.

Yet another usage situation is 60c—a so-called “Teen Card”—where a parent obtains SPANs and gives them to a minor, so that the minor can use them whenever a credit or debit card transaction is needed. In this situation, modifiable conditions can be set such that a parent—the original account owner—can modify certain usage conditions, for example, total face value of a SPAN or its expiration date, and can monitor those conditions, but is not able to monitor other variables, such as, for example, velocity of a particular SPAN or merchants where the SPAN has been presented (see FIG. 7).

Another possible usage situation is 60d, where a SPAN is used as a gift certificate—it is created by a customer 100 with a specific credit limit and is gifted to a third party, who may use it wherever standard credit or debit cards are accepted.

SPANs may be used in conjunction with wireless devices 54 in usage situations 60f, where they are presented during wireless payments transactions. In such transactions, a wireless device 54 sends one or several numbers to a device capable of accepting such numbers using standard communication protocols. A wireless device 54 in this scenario may be a cell phone, a PDA or other device capable of wireless communication, such as for example devices communicating using Bluetooth wireless protocol. In addition to aforementioned usage situations 60, there are many more situations 60e where a SPAN can be used instead of a standard financial instrument.

FIG. 2. is a flow diagram of the authorization process that occurs when a SPAN is used instead of a standard financial instrument in a commercial transaction. In that transaction, customer 100 uses SPAN 20 with its associated sets of usage parameters. These parameters are presented to merchant 200. Merchant 200 may be an online merchant, such that the parameters are presented during an online transaction, or during a phone transaction. Alternatively, SPAN 20 can be encoded within a magstripe on a physical card which is presented to merchant 200 instead of a credit card. In order for merchant 200 to accept SPAN 20, he should be enabled to accept standard credit card payments. To accept credit card payments, merchant 200 must have an account with a merchant bank 210 that offers credit card processing service. The authorization process then proceeds as follows:

1. When customer 100 decides to make a payment using a SPAN, merchant 200 requests from customer 100 authorization parameters, such as a SPAN, and its associated expiration date and customer's address and phone numbers. Customer 100 submits the requested information.

2. Merchant 200 sends transaction information to the merchant bank 210 for authorization. Authorization is a request to verify available funds and to hold them if they are available.

3. Merchant bank 210 sends the authorization request through one of appropriate payment networks 320.

4. Authorization requests are received either by SPAN issuing bank authorization system 73 or SPAN Issuing Bank Settlement System 71, depending on the payment network used, from where the authorization request is passed on to programmable payments module 300 through a payment switch 305.

5. Within programmable payment module 300, an authorization module (see FIG. 6) proceeds to either acquire the authorization or to reject the authorization request.

6. The authorization or rejection obtained in step 5 are passed back to merchant 200 through the same communications means are in steps 2-4. Upon receipt of authorization, merchant 200 proceeds with the transaction. Upon receipt of a rejection, merchant 200 notifies customer 100 that his SPAN has been rejected.

In addition to the steps outlined above, a customer may be notified of received authorization request and its outcome through customer interface module 401. Further, customer 100 can at any time use online interface 50 to connect to customer service module 400 and receive information about any past transactions by submitting customer inquiry 47. Authorized customer proxy 43, such as a parent, purchasing manager or some other third party, may also access the customer service module to receive the same or slightly restricted information. If the customer contacts customer service representative 49, the representative 49 may also access the customer service module in order to obtain past transaction information.

All transaction information, as well as settings about who may access which parameters of customer 100's primary account are stored in databases 35, which include SPANs database 351, primary account database 352, authorization parameters database 353, merchant database 354, customer preferences database 355, usage parameter database 356, transaction database 357, database of agencies in the financial network 358, and other databases 359 (see FIG. 6).

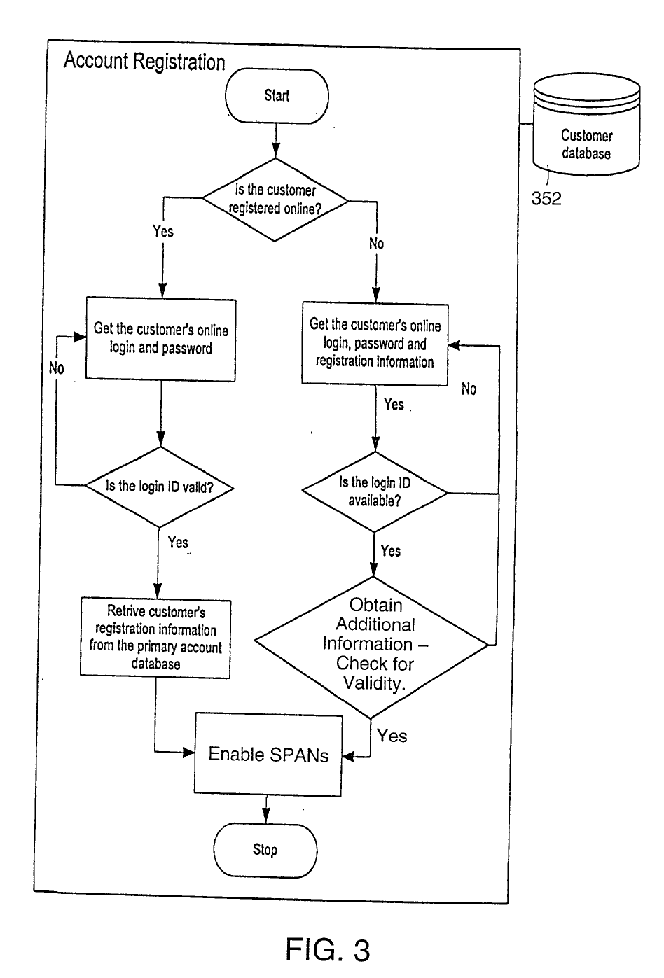

As stated above, in order for customer 100 to receive SPANs and be able to use them instead of regular financial instruments, customer 100 must register for a primary account with programmable payments module 300 and register at least one primary financial instrument with which new SPANs may be associated. FIG. 3 is a flow diagram of the primary account registration process. In the illustrative embodiment, this registration proceeds through online interface 50 described above, but it could alternatively be performed by a customer representative over the phone, by a person's transactions in a physical bank or in other ways.

Referring to FIG. 3, the account registration process for customer 100 starts with a check of whether the customer is already registered with online database (it is possible that the customer 100 is already registered and does not realize it or that he is already a member of one of the organizations that are supporting programmable payments module and has an account through previous relations with them). If the answer to that check is “yes,” then the process proceeds to request and check the customer's online login ID and password. Once the login ID and password are ascertained to be valid, customer registration information is retrieved from the primary account database 352 and the account is enabled for obtaining SPANs.

If the customer is not already registered with the programmable payments module 300, the registration proceeds by requesting customer 100 to create a login ID and a password. If a chosen login is not available, the customer is prompted to enter a different login ID, until a requested login ID is available. Once the login ID and password are determined, the customer is asked for additional information which is needed in order to create or verify a primary account. All the information is checked for validity. Once the validity of the information is established, the account is activated and stored in customer database 352 and is enabled for obtaining SPANs.

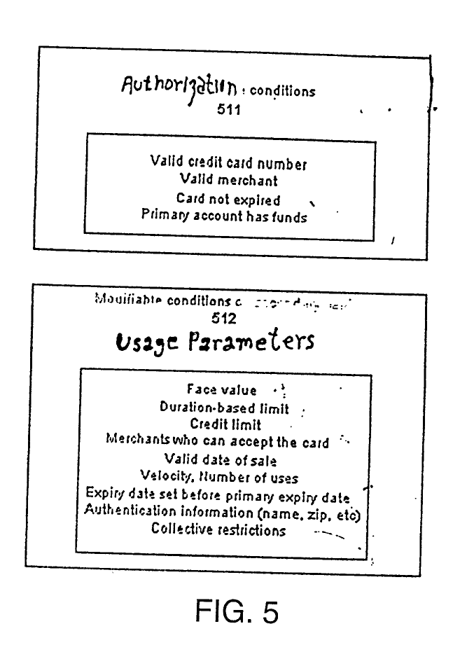

Referring now to FIG. 4, every primary account 103 may be associated with a set of SPANs. The relationship is one to many, so the number of SPANs per account is limited only by policy considerations or by the total number of available SPANs. In turn, each SPAN 1000 has associated with it usage parameters 512 and authorization conditions 511. The relationship between SPAN 1000 and its usage parameters and authorization conditions is 1:1, which means that for any SPAN, there is only one set of each of usage parameters and authorization conditions. Appropriate usage parameters are further described in FIG. 5.

SPANs are similar to standard credit card accounts in that they have associated with them certain parameters, such as usage limits and expiration dates. The issuer (in this case, programmable payment module 300) authorizes the account for a charge only if the usage is within the specified limits. Unlike ordinary credit cards, however, SPANs provide much greater flexibility in possible usage parameters and their limits. For example, a customer can set a monthly limit on a SPAN (for example, a dollar limit and or a number of transactions limit). Charges on this SPAN will be authorized only within the specified limit. The customer can thus limit the risk of fraudulent charges on that SPAN. A SPAN can also be set up such that it is authorized for presentation to a single merchant or class of merchants 200 and no other, or certain merchants or classes of merchants may be included. These and other restrictions are achieved through appropriate settings of usage parameters and authorization conditions.

Referring now to FIG. 5, some of the usage parameters and authorization conditions are described. The list presented here is not exclusive and may be augmented by additional parameters allowing for yet more flexibility in setting usage limits on a per-SPAN (or per group of SPANs) basis. Authorization conditions 511 may not be changed by the customer once the SPAN is issued and are controlled and modified only by programmable payments module. Usage parameters, on the other hand, are recomputed after each transaction or may be modified by a customer or even a third party to whom a particular SPAN is assigned.

Authorization conditions include:

1. Valid SPAN number: Valid SPAN number is generated during SPAN-issuing process (see FIG. 7).

2. Valid user: is a customer or a third party who is authorized to be using the SPAN.

3. SPAN not expired: is a binary value computed by programmable payments module 300 based on other usage parameters.

4. Primary account has funds: is important in case a SPAN is associated with a stored-value account. In a stored-value primary account, funds are drawn from the associated financial instrument when a SPAN is issued, and thereafter a SPAN acts as a debit instrument on that stored value.

Usage Parameters Include:

1. Face value: This is the total expenditure possible on the SPAN. Authorizations for charges after the total balance exceeds the face value are denied. The customer can set and modify this parameter to limit the total usage of the account. By setting the face value to $100, for example, the customer will be able to generate an account payment entity that can be charged multiple times, but not cumulatively more than $100. Modifying the face value gives additional flexibility to the customer.

2. Duration-based limit: This is the total expenditure possible on the SPAN in a specific duration. This parameter is similar to face value, but offers control over periods. By setting the duration-based limit to for example $100 a month, the customer will create an account that can be charged at most $100 in any month. Such accounts can be given as gifts to children or deposited for a single merchant who makes recurring charges. The duration-based limit could be aggregated or reset on completion of the specified duration. In the previous example, $100 could be the maximum limit in a month, or could be a similar deposit made every month. If $75 is spent in a month, the remaining $25 could be made available for the next month. In other words, the $100 could be though of as a “spending restriction” or as “pocket money” given every month.

3. Credit limit: In cases where the primary account holder makes specific payments to SPANs, a credit limit can be associated with the SPAN. The credit limit is the maximum outstanding credit the SPAN can have. Payments made to the SPAN will increase the available credit. Such an authorization parameter is especially useful when the primary account owner gifts the SPAN to someone.

4. Merchant restrictions: The use of the account can be limited to a single merchant, to certain specified merchants or to a class of merchants (i.e., gas stations). This helps the customer create gift accounts. Such restrictions can also be helpful in other cases. For example, the owner of an account may give a SPAN to an employee that is valid only with one certain merchant. This reduces the risk of wrong use if the employee has no personal interest in products sold by that merchant. The restrictions on a merchant can be made on the terminal point-of-sale device, merchant name and the merchant bank account. Merchant restrictions may be specified during SPAN initialization process. Alternatively, they can be set by making merchant restrictions parameter “sticky.” What that means is that during the original SPAN initialization a merchant restriction is not specified, but once the customer uses SPAN at a particular merchant, that merchant is “stuck” to the Merchant Restrictions parameter, such that from there on that SPAN can only be used with that particular merchant.

5. Merchant Exclusions: Restrictions also work in another way. A specified list of merchants, a category or class of merchants can be excluded from the list of merchants where the SPAN will be accepted. If the account number is used in any of the merchants except the ones in the list specified, the transaction will be allowed to go through. Merchant codes can be used for either merchant restrictions or exclusions.

6. Date of sale: Authorization of a charge can be limited by the date of sale. For example, if a customer sets the date of sale on a card as Dec. 25, 2000, the customer could make purchases on that date only. Further charges made by the customer, or any illegitimate person who gained access to the account information, cannot be made.

7. Velocity: The term velocity refers to the number of times the account can be charged per month or other selected period. The velocity of an account can be set and modified by the user. The authorization parameter “number of uses” can be controlled by appropriate selection of the velocity.

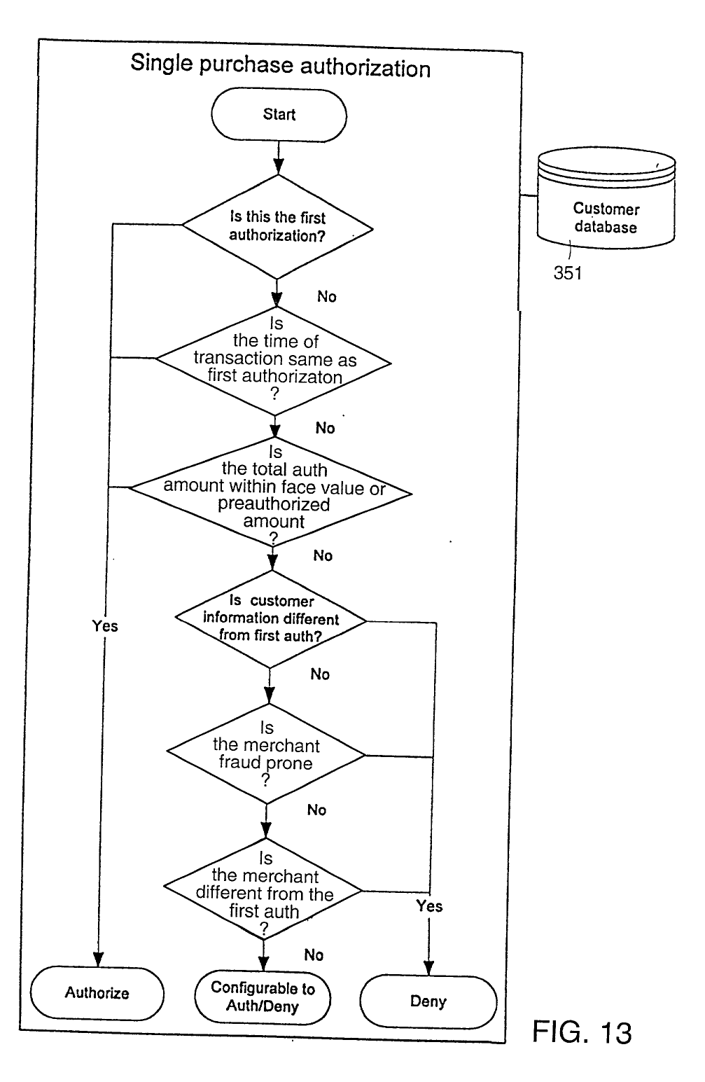

8. Number of uses: The customer can specify the number of times the account can be authorized. If this number is set to one, the customer reduces fraudulent charging on the account once the transaction has been made. Additionally if the credit limit is set, the SPAN payment is similar to a check payment. Even after the number of uses has been exhausted, the customer can increase the number of uses and make more charges on a SPAN so long as the SPAN has not expired. A common use for the number of uses parameter would be to set it to one during SPAN creation. With such a setting, that SPAN will only be used once. However, often a single purchase on a merchant's site does not guarantee a single authorization (which is the way the number of uses parameter is updated). For example, a merchant may be an online merchant which ships items as they become available, even if they were purchased at once, and bills for them as they are shipped. In such a scenario, a single purchase can result in several authorization requests. In order to handle such a situation, there is a so called “single-purchase authorization process”, further described in FIG. 13, which attempts to judge whether a series of authorization requests are in fact parts of a single purchase.

9. Expiry date: The customer has control over the expiry date on the account. Although reducing the expiring date may not normally be useful given the other authorization parameters, the customer could choose to extend the expiry date and hold the SPAN for more time, so long as that is done before the SPAN expires. Expiry date can also be specified as “day of month-month-year” instead of just “month-year” as for traditional account expirations. In some instances, even shorter time periods can be selected for the life of a SPAN. For example, where a SPAN is issued for a specific transaction, it could expire one hour from issuance. This gives a further control on when exactly the SPAN expires.

10. Authentication information: Account payments require some authentication information, such as cardholder name, billing address, zip code, etc. The merchant usually requires some authentication information not embossed in the account. The authentication information can reveal information about the customer, which the customer is unwilling to disclose. SPAN authentication information is controllable by the customer. The customer can therefore avoid revealing personal information to merchants. Privacy may for example be enhanced by the customer using a pseudoname for the SPAN or a transaction.

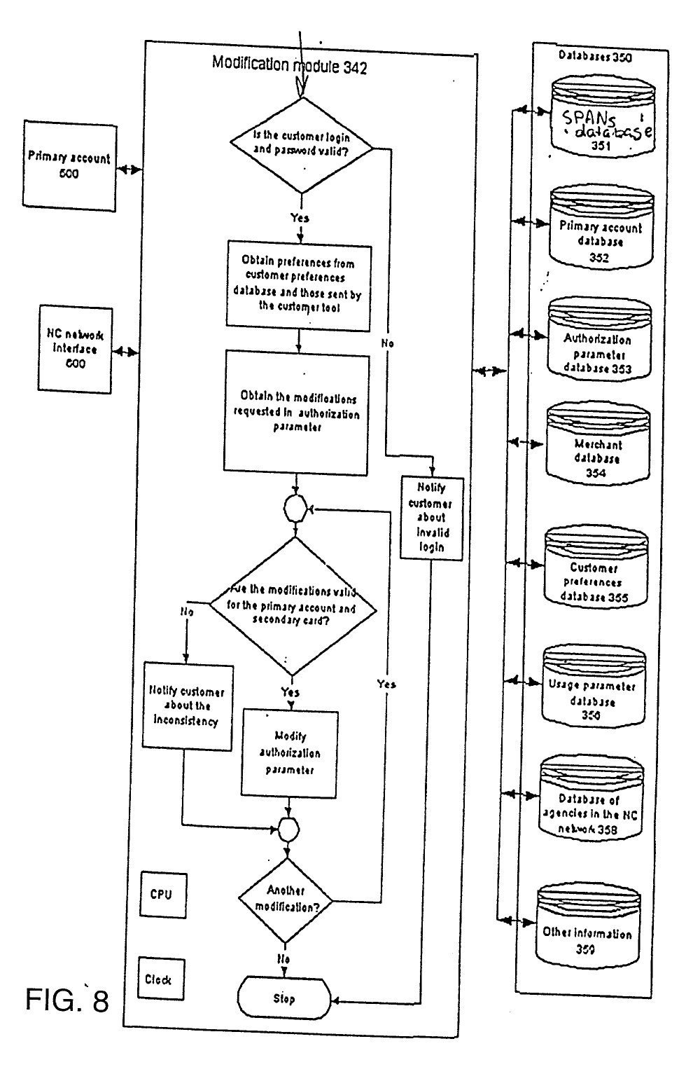

11. Collective restrictions: Restrictions mentioned above could be placed on collections of SPANs, called books of SPANs (see FIG. 8). For example, the customer could obtain 10 SPANs with a total face value of $100. This is useful to the customer in limiting the liability to $100 if all the 10 numbers are stored physically in an insecure place. The customer can also gift “secure” SPANs that can be used once (by default), with a cumulative face value.

12. Purses: Purses are sub-units of a single SPAN. Each purse could act as a way of imposing limits on a category of merchants or category of products that the SPAN could be used for. For example, a single SPAN with a total face value of $1000 could have 3 purses. The first purse could have a limit of $300 for purchases on, say movie tickets. The second purse could have a limit of $400 for purchases on clothing. The third purse could have a limit of $500 for purchases on music products such as compact discs and compact disc players. When the SPAN is used against these purchases, the purchase on each purse is monitored. If a purchase is made on, say movie tickets, the system will ensure that the sum of all movie ticket purchases made on the SPAN does not exceed $300. The system will also ensure that the total amount of all the purchases made on the SPAN does not exceed $1000. The second and the third purses work the same way. Another case of the above example is when the sum of limits on all the purses is equal to the face value of the SPAN.

All the aforementioned parameters are stored and accessed through the programmable payment module 300 interfaces. Programmable payment module includes several databases (see FIG. 6), an authorization module 330 (see FIG. 6), a customer module 340 (see FIG. 7), a modification module 342 (see FIG. 8), an issuing module 341 (see FIG. 9), and other modules.

Referring now to FIG. 6, an authorization model 330 is discussed. The authorization module obtains an authorization request for a transaction from financial network 320 through payment switches 305, as described in FIG. 2. The authorization process proceeds through the following steps:

1. Verification checks made on authorization conditions. To perform these checks, the authorization module needs to be interfaced with the primary account 101 of the customer, and databases 350 storing relevant information. The SPAN database 351 is queried to verify the validity of the SPAN and to find the related primary account if valid. Authorization conditions are loaded from the authorization parameter database 353 and the modifiable parameters are checked with credit card usage information as stored in the usage information database 356.

2. The primary account database 352 is then used to check for available funds. If the SPAN is not used in value stored mode, in order to check for available funds, the authorization module may need to query issuing institutions for the primary financial instrument to which the SPAN is assigned by sending an authorization request to that issuing institution.

3. If the authorization in step 2 is acquired, the funds in the primary account are held for this transaction (the process of requesting authorizations from financial instruments issuing institutions also holds those funds).

4. SPAN usage parameters are updated in a manner appropriate for each parameter. The new usage parameters are stored in the usage parameter database (356). Among the non-modifiable conditions, the funds in the primary account changes after every approved authorization. For example, if a purchase of $100 is made, the amount of funds available is reduced by $100. Among the modifiable conditions, the following usage parameters are updated after approval of funds: face value, duration-based limits, velocity (number of uses) and collective equivalents of these usage parameters. Simple routines can be devised to compute changes in usage parameters. All dollar-valued usage parameters, such as face value, duration-based limits, funds in primary account, and other monetary parameters, are reduced by the transaction amount. The velocity and its collective equivalent is reduced by 1 for every approved authorization.

5. An authorization code needs to be sent through the financial network, to the merchant bank to indicate successful authorization. The code has to be unique, so that the merchant bank can later use it to identify the transaction. An authorization code generator (360) is used to generate the authorization code (520). The transaction is then recorded in the transaction database (357). The transaction database will be queried by subsequent operations, such as settlement. The transaction database is used by the service module (343), shown in FIG. 7, to generate statements, answer customer queries and help transaction auditing during the clearing and settlement processes.

6. The authorization code is sent through the financial network to the merchant bank.

7. If customer preferences indicated that the customer should be notified upon a successful authorization, the customer is notified through notification interface 400 (FIG. 1). The decision to notify the customer is based on the customer preference stored in the customer preferences database (355).

If any of the above checks fail, the authorization request is rejected. The rejection is sent back to the merchant bank. In addition, based on customer's preferences, a customer may be notified of the rejection and the reason for it.

Referring now to FIG. 7, a customer module 340 and associated customer tools 110 are described.

The customer can change parameters associated with modifiable authorization conditions 512 stored in the authorization parameter database 353. The customer uses a user-friendly customer tool 110 to interact with the customer module of the programmable payments module 300. Interaction happens through online interface 50. The customer logs on to the online interface using his login ID 120 and password 121 (see FIG. 8). The customer's preferences can be stored on the client side in a local-preferences database 111. These preferences are sent to the to the programmable payments module through customer module 340 when account modification takes place. The customer tool 110 can be further customized using the default-parameters database 112. For example, the tool could obtain a SPAN by default on execution. The SPAN obtained will be set with preferences based on the databases 111 and 355. In another embodiment, the customer tool 110 will obtain customer preferences through the process of “screen-scraping”—that is, monitoring customers access to websites asking for personal and financial information and recording appropriate data.

The customer module 340 includes issuing module 341 (see FIG. 9), modification module 342 (see FIG. 8) and service module 343 (see FIG. 9). The issuing module issues new SPANs. The modification module can be used to modify authorization parameters on secondary credit cards. The service module provides general services to customers.

The SPANs issued by the customer module are sent through the issuing interface 700 that could be different from the programmable payment module 300 interface. The issuing interface can send the SPANs directly to another customer 100 authorized by the purchasing customer to use the SPAN. The issuing interface could be a form of physical mail, electronic mail, messaging system or a vending device such as ATM. The customer could choose to personally give the secondary credit card or its information to a third party. In another embodiment, the issuing interface prints out physical representations of SPANs—from a list of numbers on paper, to magnetically encoded magstripe on a plastic card (done with appropriate magstripe writers). Such physical representations may be read by a human, or by an OCR mechanism when scanned into a computer or (in case of a magstripe), by a card reader.

Referring now to FIG. 8, a preference modification process is illustrated. The customer login 120 and password 121 are checked with the correct values stored in customer preferences database 355. If correct, the modification module allows entry to the customer and loads his or her preferences. The customer can make modifications to existing SPANs belonging to the customer. Modifications can be made on any modifiable condition (512). For example, the customer can increase the face value of the card from $100 to $200. In another scenario, a customer may chose to associate the existing SPAN with a different primary financial instrument than the one it is currently associated with. Each financial instrument can have separate “purses” of SPANs, each containing a set of SPANs and each having a separated name, such that when a customer activity report is issued, SPANs associated with a particular purse show up under that name.

Modifications to parameters 512 on SPANs have to satisfy certain checks for consistency. Dollar-value based limits and velocity cannot be reduced below zero. Valid merchants should be chosen in the list of merchants who can accept the card. SPAN expiry date should be before the primary financial instrument expiry date. Authentication information should be consistent with the format required by the financial network 310. If these modifications are permitted and do not violate consistency of the system, they are made in the authorization parameter database 353. Changes can also be made to preferences in database 355. The SPANs database 351, primary account database 352 and usage parameter database 356 are queried to ascertain relationships and conditions during the execution of the modification module.

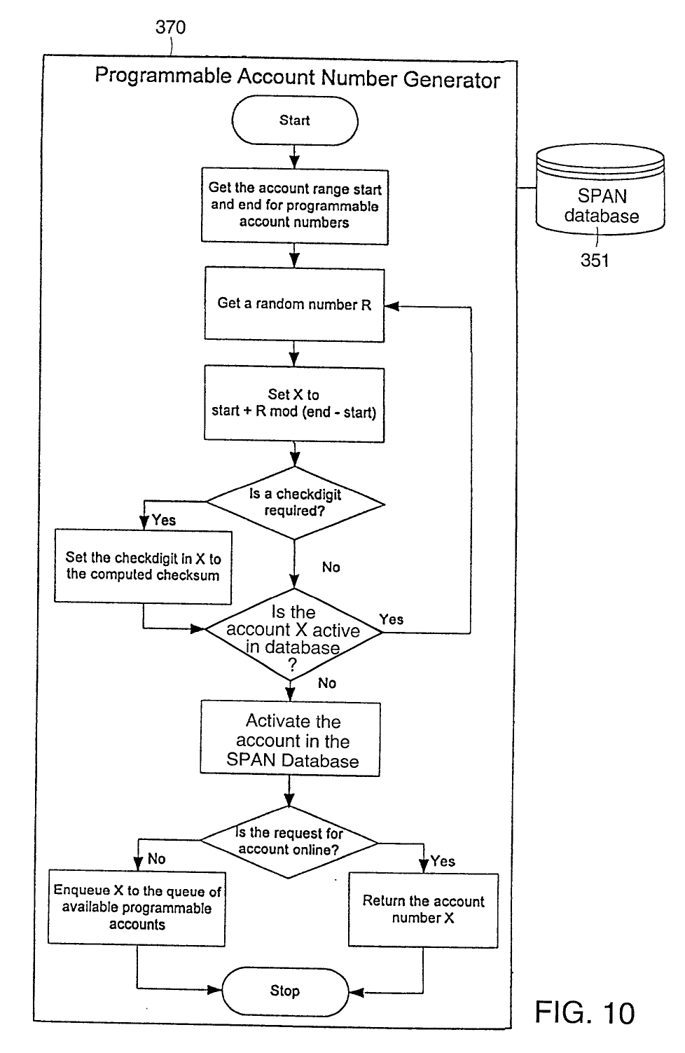

Referring now to FIG. 9, a SPAN-issuing process is illustrated. The issuing module 341 performs the same login ID and password check on the customer as the modification module in FIG. 8. If SPANs can be issued to the customer, the SPAN number generator 370 is invoked (see FIG. 10). The number generator can maintain a database of pre-computed numbers to reduce the risk of computational overload on the CPU. These pre-computed numbers are stored in a SPAN queue and may be issued to a customer upon request either one by one or in sets.

The databases storing SPANs 351, primary accounts 352, authorization parameters 354, customer preferences 355 and usage parameters 356 are all updated to account for the newly created SPANs. The customer is allowed to define modifiable parameters on new SPANs. These parameters may be explicitly specified by the customer, loaded from the customer's preferences, or set to be default parameters. The issuing module 341 uses the modification module 342 to set the various parameters defined on SPANs.

Referring now to FIG. 10, a SPAN generator and its operation are described. It uses a pseudo-random number generator in order to get a random number R. Once the random number R is generated, certain mathematical permutations are performed on it in order to obtain a valid credit card number that complies with a standard credit card number protocol, such as having a check-digit and a checksum. Random number R is then checked against the SPANs database 351. If R is already in the database, it is discarded in order to avoid duplicates, and the module proceeds to generate a new number R. If R is not in the database, it is added to database 351 and is activated as a SPAN. Using a pseudo-random number generator to generate R may take considerable computational resources and takes a period of time that may be unacceptable in rapid online transactions with a large volume of SPAN requests. In order to facilitate fast SPAN creation, SPANs can be pre-computed during a time of slow activity and stored in SPAN queues (not shown).

There is a limit on the total number of valid SPANs that can be issued imposed by system policies and the maximum number of available digits. Therefore valid SPANs can be re-issued after a predetermined period after their deactivation.

If the original request was from a customer who is currently online, the generated number is returned to the requesting module. Otherwise, it is appended to the queue of valid SPANs. Later, when a customer requests a new SPAN, it may be retrieved from this queue instead of being generated. Alternatively, a whole set of SPANs may be retrieved from the queue and presented to customer 100 as a book of SPANs for future use, for example as described above in conjunction with usage situations in FIG. 1.

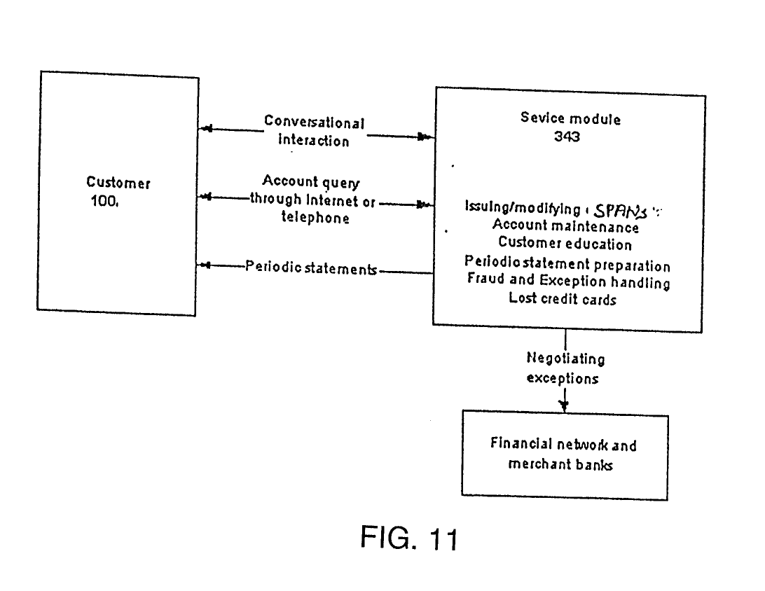

Referring now to FIG. 11 the service module 343 of the programmable payment module 300 is described. Customers 100 can contact the service module in case they need help maintaining their accounts, or have to report a missing card/fraudulent use. The preferred mode of communication to the service module in case of problems that require specific attention is telephone. For other queries, online interface 50 or an automated telephone system can be used. The service module also prepares periodic customer activity statements and sends them to the customer. The preferred functionality of the service module is very similar to functionality of present day customer services and online Internet services. Service module 343 may be used in other customer interaction and database maintenance tasks.

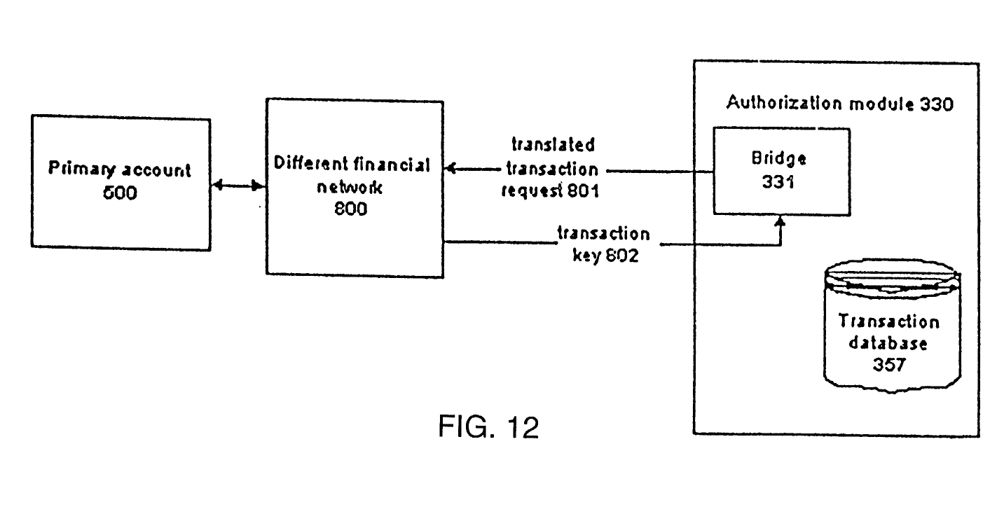

Referring now to FIG. 12, a modified version of the authorization module of the illustrative embodiment is described. As mentioned in description of the authorization module, during the authorization process it is necessary to obtain authorizations from the financial institution that issued the primary financial instrument on which a particular SPAN is operated. If the issuing financial institution (not shown) is part of the programmable payment module 300, no complications arise and the authorization can be directly obtained. However, the issuing financial institution might be a part of an entirely different financial network 800. For example, the primary financial instrument in question may be a checking or savings account and not a credit or debit card.

As shown in FIG. 1, there exist switches to different financial networks, which are utilized when the authorization is required for a different issuing financial institution. This present embodiment includes a method of integrating different modes of payments based on different financial instruments. A credit card number is used as an address to an account that may not be accessed directly using the credit card financial network. FIG. 12 shows how two financial networks can be tied using a “bridge” 331 in the authorization module. The bridge translates authorization and settlement requests 801 to the protocols specific to another financial network 800. This financial network could potentially be any electronic fund transfer network such as another credit card network or a check processing network. The second financial network performs the verification and holding of funds in the primary account. A transaction key 802 associated with a transaction is stored in the transaction database 357. This key is recognized by the second financial network 800. So any query regarding such a transaction is handled in the programmable payment module 300 by forwarding the request to a different financial network 800 through bridge 331. This method of executing inter-network transactions is useful in case of business-to-business operations, where businesses can use SPANs as well as purchase order forms and checks drawn on various accounts.

FIG. 13 illustrates yet another aspect of the current invention—a single purchase authorization process. Single purchase authorization is a mode of authorization process that takes place for SPANs with number of uses set to 1 during the issuing stage. Such SPANs are authorized only for a single purchase. However, various merchants ship articles purchased as they become available and may bill for them separately as well, which will result in several authorizations for a single purchase. In a conventional single-use card system, such additional authorizations will be denied. In programmable payments module 300, however, there is a single purchase authorization module designed to use decision heuristics in order to identify a set of separate authorizations that may all be in fact one purchase.

The single purchase authorization process includes the following steps:

1. Check whether the present authorization is the first one. If yes, authorize it. If not, proceed to the next step.

2. Check whether the time of transaction is the same as transaction time for the first authorization. If yes, authorize the purchase; if not, proceed to the next step.

3. Check whether the total authorization amount is within the face value of the SPAN or is smaller or equal to the pre-authorized amount in the stored value case. If yes, authorize the purchase; if not, proceed to the next step.

4. Check if the customer information is different from the first authorization. If yes, deny the request; if no, proceed to the next step.

5. Check if the merchant is fraud prone, as recorded in merchant database 354 (see FIG. 7). If yes, deny the authorization request; if no, proceed to the next step.

6. Check if the merchant is different from the merchant in the first authorization. If yes, deny the request; if no, proceed to the next step.

7. Authorize or deny the request, depending on the system preferences settings, which may be modified at any moment to reflect the current system policies.

This flexible authorization process allows the authorization module to recognize several authorization requests that are parts of the same purchase and to authorize them all.

The invention has been illustrated and described in detail in the drawings and foregoing description. This should be considered as illustrative and not restrictive in character, however, in that only the preferred embodiment has been shown and described. All changes and modifications that come within the spirit of the invention are desired to be protected.

Another means of solving this problem is by issuing a primary PIN and multiple secondary PINs to an account. The PIN is a field that is verified by the issuer while making an authorization. Adding a PIN to the account number provides a means of increasing the range of numbers available. Specifically, the account number along with the PIN can be made to address a unique programmable account. Now the programmable account is not associated just with the number, but also with the PIN associated with the card. By augmenting a PIN to the account number, the issuer can increase the number of possible unique programmable accounts. In fact, the issuer could assign a single account number to all programmable accounts issued to a customer. Different values of the PIN field will correspond to different programmable accounts. Now we can implement all the functionality mentioned above, using the same account number for multiple programmable accounts. The issuer should ensure, however, that the programmable accounts with the same account number have unique PIN fields.

Fraud is another potential problem. The Programmable Payment network can impress a sense of security among the customers. Apart from permitting the customer to control his or her transactions in certain special ways, the Programmable Payment network notifies the customer regarding the status of his or her accounts. For example, the Programmable Payment network could send information regarding the recent authorizations or violations made on the customer's accounts, to the customer. A customer can thus get feedback about his charges, without waiting for the monthly statement or explicitly trying to get his information. This notification can be communicated to the customer via a communication media such as electronic mail, pager, cellular telephone, fax or postal mail.

The notification scheme can be used for fraud prevention too. For example, upon notification, a customer can realize that the charge made is incorrect. Using a potentially different communication medium the customer can inform the Programmable Payment network about the fraudulent charge. The Programmable Payment network could immediately take action to ensure that the transaction is reversed, or not reflected on the customer's primary account.

The Programmable Payment network can also be integrated with existing fraud detection systems. Existing fraud detection systems look for patterns in primary account authorizations that exhibit potentially fraudulent behavior. Some of these fraud detection systems are implemented in the financial network. Since the financial network receives programmable account numbers and not the primary account numbers, these fraud detection systems may be useless. However, the Programmable Payment network can inform these fraud detection systems about primary account numbers used against the programmable account number. If the Programmable Payment network obtains an online approval from the fraud detection system before approving authorizations, the fraud detection systems become functional. Alternately, the Programmable Payment network can react to observations made by the fraud detection system. For example, if a merchant is blacklisted by the fraud detection system, the Programmable Payment network can deny all charges made by that merchant.

The Programmable Payment network can detect fraudulent patterns too. For example, if excessive denials are made on a programmable accounts by a particular merchant, then the Programmable Payment network can infer that the merchant is fraudulent or fraud “prone.” Subsequent authorizations using the programmable payment system to pay for that specific merchant are denied.

Programmable accounts used at a single merchant are superior to primary accounts with respect to tracking fraudulent activity. For example, if a programmable account used only at merchant A is used fraudulently at another merchant, the payment network can “infer” that the security of account information at merchant A's has been compromised.

The customer can assign a particular programmable account to a particular merchant. In addition, he or she can set face value, monthly limits or velocity on the programmable account to limit liability of fraud on the account. Fraud can also be controlled by the customer setting or changing usage parameters on a SPAN usable only by a selected merchant to ensure that the merchant can charge the account only for the purchases made by the customer. This proves useful when dealing with “recurring” or periodic payments. For example, a customer can manually add or change the face value and/or number of uses appropriately just before he or she decides to make a purchase at that merchant. This will ensure that the merchant will be able to charge the programmable account only for the purchase made by the customer. This would protect customers from fraudulent or other unauthorized charges made by the merchant (for example monthly charges from a book or record club for unordered/unwanted merchandise). The advantage of this scheme is that the customer need not give a different programmable account for every purchase. Instead, a single programmable account can be stored in the merchant database and the customer can take advantage of the convenience of not having to enter his account information for every purchase (one-click process).

In order to convert “card-not-present” transactions into “card present” transactions even when the transaction is conducted over the Internet, several additional authorization steps are possible. (1) The cardholder can be required to enter a number from a device carried by the cardholder into the merchant's web site. The device carried by the cardholder displays a pseudo-random number whose sequence is also known by the server accessible to the Programmable Payment network or module. The pseudo-random sequence is created to be extremely difficult to reproduce. The server generates a sequence of random numbers—called a window of numbers—including enough numbers both before and after the “next” number so that the server is able to deal with differences in the speed of the clocks in the server and in the cardholder's device. The number entered by the cardholder must match one of the random numbers in the window of numbers generated by the server to authenticate the cardholder. (2) The cardholder can present a dongle to a reader in order to authenticate their presence. The dongle may use RF (Radio Frequency) or other means to transmit its identity to the reader. The dongle is sufficiently difficult to reproduce to allow it to securely identify the cardholder.

The Programmable Payment network can also be used in a physical presence by customizing a magnetic stripe, or magstripe, on a credit card. The cardholder can carry a device, perhaps attached to a cellular phone or a personal digital assistant (PDA), which can encode (write) the magstripe on a credit card. Using this technology, the cardholder can create a new payment number and write the number onto a physical plastic card for use at a merchant. The number can be altered for each use of the payment card. The card will be accepted as a standard credit/debit/stored value payment card.

Finally, the Programmable Payment network does not require the merchants to change any of their existing systems. The merchants can use existing payment terminals and existing transaction processing systems to process transactions for a SPAN as they would for a primary account number. Minimal change would be required in other existing infrastructure.

While the invention has been illustrated and described with reference to a preferred embodiment and modifications thereof, this description should be considered as illustrative only and not restrictive in character. In particular, the foregoing and other changes in form and detail may be made in the invention by one skilled in the art while still remaining within the spirit and scope of the invention, which invention is to be defined only by the appended claims. All changes and modifications that come within the spirit of the invention are desired to be protected.

1. A module for issuing secondary programmable account numbers (SPAN's) to a customer including:
a verification module which receives SPAN requests from a customer and verifies the validity of such request;
a generating module operative in response to a verified SPAN request for providing at least one SPAN, each SPAN being associated with at least one customer financial instrument;
a usage module assigning usage parameters to the SPAN's; and
an issuing module which issues each SPAN to a customer specified party, the issued SPAN being usable only within the assigned usage parameters.

2. A module as claimed in claim 1 including a memory storing preferred usage parameters for customers, said usage module utilizing the preferred usage parameter for the customer as default usage parameters for each SPAN for the customer.

3. A module as claimed in claim 2 wherein each customer SPAN request can include at least one usage parameter, the usage module assigning the at least one usage parameter of the request to the corresponding SPAN in lieu of the corresponding preferred usage parameter.

4. A module as claimed in claim 1 wherein each customer SPAN request can include at least one usage parameter, the usage module assigning the at least one usage parameter of the request to the corresponding SPAN.

5. A module as claimed in claim 1 wherein said usage parameters include at least two of SPAN duration, SPAN face value, SPAN credit limit, permitted merchants, excluded merchants, value velocity, use velocity, period of use, and number of uses for the SPAN.

6. A module as claimed in claim 5 wherein said usage module includes mechanisms for altering at least one of the usage parameters for an issued SPAN in response to a request from at least one of the customer and the party to whom the SPAN is issued.

7. A module as claimed in claim 1 wherein said issuing modules issues at least selected SPAN's to a third party designated by the customer.

8. A module as claimed in claim 1 wherein the customer has a plurality of financial instruments, and wherein said generating module includes a mechanism for selecting the financial instrument with which each SPAN is associated.

9. A module as claimed in claim 8 wherein the financial instrument selected for each generated SPAN is the same as the instrument selected for the previously generated SPAN unless the customer otherwise indicates.

10. A module as claimed in claim 8 wherein the financial instrument selected for a SPAN can be charged by the customer after the SPAN is issued.

11. A module as claimed in claim 1 wherein said generating module generates and stores a plurality of acceptable SPAN's; and
wherein the at least one SPAN provided in response to a customer request is provided from the stored acceptable SPAN's

12. A module as claimed in claim 1 including a magstripe writing device, said issuing module operating said writing device to record a SPAN to be issued on a magstripe of a suitable token.

13. A module as claimed in claim 1 wherein said generating module provides a plurality of SPAN's, said issuing module issuing said plurality of SPAN's as a book to which said usage parameters are assigned.

14. A module as claimed in claim 13 wherein said usage module assigns at least one usage parameter to each book, each SPAN in the book being usable so long as the cumulative use of the SPAN's for the book do not exceed any usage parameter assigned to the book.

15. A module as claimed in claim 1 wherein a SPAN is usable to access funds from a customer-selected financial instrument.

16. A module as claimed in claim 1 wherein said financial instrument is a checking account.

17. A module as claimed in claim 16 wherein a SPAN is assigned to a check usable as a check and as a credit card number.

18. A module as claimed in claim 1 including a bridge permitting use of SPAN's across financial networks having different protocols.

19. A module as claimed in claim 1 wherein one usage parameter is SPAN duration, a SPAN normally remaining viable for its assigned duration.

20. A module as claimed in claim 19 wherein the customer can access the usage module after a SPAN is issued to change its assigned duration.

21. A module as claimed in claim 19 wherein said durations are specifiable in time intervals not exceeding days.

22. A method for issuing secondary programmable account numbers (SPAN's) to a customer including:
a) the customer inputting a SPAN request to an issuing system;
b) the system verifying at least one of the customer and the request;
c) the system providing at least one SPAN in response to a verified SPAN request, each SPAN being associated with a selected customer financial instrument;
d) the system assigning usage parameter to the SPAN's; and
e) the system issuing each SPAN to a customer specified party, the issued SPAN being usable by such party only within the assigned usage parameters.

23. A method as claimed in claim 22 wherein the system stores preferred usage parameters for customers, the system utilizing the preferred usage parameter for the customer as default usage parameters for each SPAN for the customer.

24. A method as claimed in claim 23 wherein each customer SPAN request can include at least one usage parameter, the system assigning the at least one usage parameter of the request to the corresponding SPAN in lieu of the corresponding preferred usage parameter.

25. A method as claimed in claim 22 wherein each customer SPAN request can include at least one usage parameter, the system assigning the at least one usage parameter of the request to the corresponding SPAN.

26. A method as claimed in claim 22 wherein said usage parameters include at least two of SPAN duration, SPAN face value, SPAN credit limit, permitted merchants, excluded merchants, value velocity, use velocity, period of use, and number of uses for the SPAN.

27. A method as claimed in claim 26 including the system altering at least one of the usage parameters for an issued SPAN in response to an input from at least one of the customer and the party to whom the SPAN is issued.

28. A method as claimed in claim 22 wherein, during step (e), the system issues at least selected SPAN's to a third party designated by the customer.

29. A method as claimed in claim 22 wherein the customer has a plurality of financial instruments, the system selecting the financial instrument with which each SPAN is associated.

30. A method as claimed in claim 29 wherein the financial instrument selected for each generated SPAN is the same as the instrument selected for the previously generated SPAN unless the customer otherwise indicates.

31. A method as claimed in claim 29 wherein the instrument selected for a SPAN can be charged by the customer after the SPAN is issued.

32. A method as claimed in claim 22 including the system generating and storing a plurality of SPAN's, and wherein the at least one SPAN provided in response to a customer request is provided from the stored acceptable SPAN's

33. A method as claimed in claim 22 including a magstripe writing device, said system operating said writing device to record a SPAN to be issued on a magstripe of a suitable token.

34. A method as claimed in claim 22 wherein said system provides a plurality of SPAN's issued as a “book” to which said usage parameters are assigned.

35. A method as claimed in claim 34 wherein said system assigns at least one usage parameter to each book, each SPAN in the book being usable so long as the cumulative use of the SPAN's for the book do not exceed any usage parameter assigned to the book.

36. A method as claimed in claim 22 wherein a SPAN is usable to access funds from a customer-selected financial instrument.

37. A method as claimed in claim 22 said financial instrument is a checking account.

38. A method as claimed in claim 37 wherein a SPAN is assigned to a check usable as a check and as a credit card number.

39. A method as claimed in claim 22 wherein one usage parameter is SPAN duration, a SPAN normally remaining viable for its assigned duration.

40. A method as claimed in claim 39 wherein the customer can access the system after a SPAN is issued to change its assigned duration.

41. A module as claimed in claim 39 wherein said durations are specifiable in time intervals not exceeding days.

42. A method as claimed in claim 22 including the system detecting the issuance of at least one of an excessive number of SPANs to a customer during a given time period and an unusual pattern of SPAN requests from a customer, and the system at least terminating the issuing of new SPAN's for the customers in response to such detection.

43. An authorization module which receives requests for authorization from a party to whom a SPAN issued in accordance with claim 1 is presented for payment, authenticates the SPAN, verifies that usage parameters for the SPAN have been complied with, denies authorization if it cannot authenticate the SPAN or if usage parameters for the SPAN are not complied with, and, if the SPAN is authenticated and usage parameters met, updates usage parameters based on the authorization request, update the associated customer financial instrument, and sends an authorization output.

44. An authorization module as claimed in claim 43 wherein a person authorized to use a SPAN has a token which facilitates identification of the person from a remote site, the authorization module receiving information from the token and utilizing such information to verify that the party is authorized to use the SPAN of the received request.

45. An authorization module as claimed in claim 44 wherein the token is one of a dongle, a card with a magstripe and a device generating a time varying value which is substantially unique to an individual at each time interval.

46. An authorization module as claimed in claim 43 wherein once a SPAN is presented for payment to a given party, the authorization module permits such SPAN to be used thereafter only for payments to such party.

47. An authorization module as claimed in claim 43 wherein a usage parameter is number times a SPAN may be used, and wherein said authorization module treats all items ordered together on a SPAN as a single use even if the items are shipped and/or invoiced separately.

48. An authorization module as claimed in claim 43 wherein the identity of the party to whom the SPAN is issued is not required as either an input to or an output from said authentication module.

49. An authorization module as claimed in claim 43 including at least one fraud detection mechanism.

50. An authorization module as claimed in claim 49 wherein said fraud detecting mechanism includes detection of at least one of an unusual pattern of authorization request from a party requesting such authorizations and an unusual pattern of use for SPAN's previously received by such party.

51. An authorization module as claimed in claim 49 wherein said fraud detection mechanism includes providing at least notification to a customer over appropriate media of at least any suspicious authorization requests for a SPAN issued at the request of such customer.

52. An authorization module as claimed in claim 49 wherein there are fraud detection programs in effect for the primary account, and wherein said fraud detection mechanism facilitates use if such programs by mapping SPANs to the corresponding primary account for such programs.

53. An authorization module as claimed in claim 43 including a plurality of purses for at least selected SPAN's, each purse being for a different category of payments, and wherein said authorization modules allocates each received authorization request for a SPAN to the appropriate purse.

54. A method for authenticating requests for authorization from a party to whom a SPAN issued in accordance with the method of claim 22 is presented for payment including:
a) authenticating the SPAN;
b) verifying that usage parameters for the SPAN have been complied with;
c) denying authorization if the SPAN is not authenticated or if usage parameters for the SPAN are not complied with; and
d) if the SPAN is authenticated and usage parameters are complied with, (i) updating usage parameters based on the authorization request, (ii) updating the associated customer primary account, and (iii) sending an authorization output.

55. A method as claimed in claim 54, wherein a person authorized to use a SPAN has a token which facilitates identification of the person from a remote site, the system receiving information from the token and utilizing such information to verify that the party is authorized to use the SPAN of the received request.

56. A method as claimed in claim 54 wherein once a SPAN is presented for payment to a given party, the system permits such SPAN to be used thereafter only for payments to such party.

57. A method as claimed in claim 54 wherein a usage parameter is number times a SPAN may be used, and wherein said system treats all items ordered together on a SPAN as a single use even if the items are shipped and/or invoiced separately.

58. A method as claimed in claim 54 wherein the identity of the party to whom the SPAN is issued is not revealed to the party to whom the SPAN is presented for payment.

59. A method as claimed in claim 58 wherein a pseudo-identity is given to the party to whom the SPAN is presented for payment.

60. A method as claimed in claim 54 including the system detecting fraud by detecting at least one of an unusual pattern of authorization request from a party requesting such authorizations and an unusual pattern of use for SPAN's previously received by such party.

61. A method as claimed in claim 54 including the system providing at least notification to a customer over appropriate media of at least any suspicious authorization requests for a SPAN issued at the request of such customer.

62. A method as claimed in claim 54 including a plurality of purses for at least selected SPAN's, each purse being for a different category of payments, and wherein said system allocates each received authorization request for a SPAN to the appropriate purse.

63. A system for facilitating access to financial instruments including:
an issuing module which provides secondary programmable account numbers (SPAN's) in response to verified customer requests, each said SPAN being associated with at least one customer financial instrument, said SPAN's having usage parameters assigned thereto; and
an authorization module which receives requests for authorization from a party to whom a SPAN is presented for payment, authenticates the SPAN, verifies that usage parameters for the SPAN have been complied with, denies authorization if it cannot authenticate the SPAN or if usage parameters for the SPAN are not complied with, and, if the SPAN is authenticated and usage parameters met, updates usage parameters based on the authorization request, update the associated customer financial instrument; and sends an authorization output.

64. A method for facilitating access to financial instruments including:
a) issuing secondary programmable account numbers (SPAN's) in response to verified customer requests, each said SPAN being associated with at least one customer financial instrument, said SPAN's having usage parameters assigned thereto;
b) receiving requests for authorization from a party to whom a SPAN is presented for payment;
c) authenticating the SPAN;
d) verifying that usage parameters for the SPAN have been complied with;
e) denying authorization if the SPAN is not authenticated or if usage parameters for the SPAN are not complied with; and
f) if the SPAN is authenticated and usage parameters are complied with, (i) updating usage parameters based on the authorization request, (ii) updating the associated customer primary account, and (iii) sending an authorization output.
